(19) United States
(12) Patent Application Publication
(10) Pub. No.: US 2019/0233329 A1
(43) Pub. Date: Aug. 1, 2019

(54) NANOSTRUCTURE LAYER SYSTEM AND METHOD FOR PRODUCTION OF A NANOSTRUCTURED LAYER SYSTEM

(71) Applicant: Achille MFUTU MASINGAKALA, Vellmar (DE)

(72) Inventor: Achille MFUTU MASINGAKALA, Vellmar (DE)

(21) Appl. No.: 16/318,045

(22) PCT Filed: Jul. 14, 2017
(86) PCT No.: PCT/DE2017/000208

§ 371 Date: Jan. 15, 2019

(30) Foreign Application Priority Data
Jul. 15, 2016 (DE) 102016008565.7

(51) Int. Cl. C03C 17/38; C03C 17/36; G11B 7/2467; G11B 7/257

(52) U.S. Cl. CPC C03C 17/38; C03C 17/3642; G11B 7/2467; G11B 2007/25706; C03C 2218/15; C03C 2218/32; G11B 7/257

(57) ABSTRACT

The invention concerns a nanostructured layer system comprising a substrate, an intermediate layer, which comprises an aromatic azo compound, applied to the substrate, and a metallic cover layer applied thereto, whereby the intermediate layer is structured in a light-induced manner by irradiation of light.

The nanostructured layer system is characterized in that the metallic cover layer contains nickel as a ferromagnetic metal and that the light is linearly polarized for structuring.

The invention further concerns a method for producing such a nanostructured layer system.

The invention concerns a nanostructured layer system comprising a substrate, an intermediate layer applied to the substrate, which contains an aromatic azo compound, in particular an azobenzene-containing low molecular weight glass, and a metallic cover layer, wherein the intermediate layer is structured in a light-induced manner. The invention further relates to a method for producing such a nanostruclured layer system.

Azo compounds are chemical compounds in which at least two functional groups are coupled via two nitrogen atoms connected by a double bond. For aromatic azo compounds, the functional groups are formed by aromatic rings. The structurally simplest aromatic azo compound is azobenzene, in which two phenyl groups are linked together by the stated nitrogen double bond.

Applied in thin layers, azobenzene-containing films exhibit light-induced reorientation phenomena due to a so-called “trans-cis-trans” photoisomerisation.

For example, Kim et al. in the article “Laser-induced holographic surface relief gratings on nonlinear optical polymer films”, Appl. Phys. Lett.

66 (10), 1995, pages 1166-1167, show that when irradiating a layer of an epoxy-based polymer containing azo compounds with an interference pattern, reorientation phenomena are generated which produce a surface structure lattice that reflects in its structure the interference pattern.

However, the resulting surface structure lattice does not have great mechanical stability.

In addition, there are thermally induced self-structuring phenomena of layer systems in which a polymer layer is covered by a metal layer. Such phenomena were first mentioned in the article “Spontaneous formation of ordered structures in thin films of metals supported on an elastomeric polymer”, Bowden et al., Nature, Vol. 393, 1998, pages 146-149. According to this article, a film of polydimethylsifoxane (PDMS) is applied to a substrate, for example a glass substrate, onto which a metallic cover layer, for example a gold or nickel film, optionally with an intermediate adhesion promoter film of titanium, is vapor-deposited at elevated temperature.

By matching the glass transition temperature to the temperature of the PDMS intermediate layer, the PDMS layer undergoes strong thermal expansion compared to the metallic cover layer. The cooling of the layer system leads to a surface structuring of the applied metallic cover layer.

A disadvantage with regard to a technical use here is that the PDMS intermediate layer and the surface structuring cannot be optically controlled by light irradiation and thus cannot be used, for example, as optical information storage.

A light-induced structuring of such layer systems was described in the article “Surface wrinkling induced by photofluidization of low molecular azo glasses”, Gruner et al., ChemPhysChem, 14, 2013. pages 424-430. According to this article, a possible influence of polarisation patterns of all kinds, for example a linear polarisation, on the structuring was excluded.

This was also evident in the isotropically oriented structures observed there.

This raises the task to provide a nanostructured layer system of the type mentioned, in which a surface structuring can be optically controlled by light irradiation and in which the resulting structure is mechanically stable.

It is a further task of the present invention to specify a method for producing such a nanostructured layer system.

This task is achieved by a nanostructured layer system or a method for producing a nanostructured layer system with the respective features of the independent claims. Advantageous embodiments and further developments are specified in the dependent claims.

An nanostructured layer system according to the invention is characterised in that the metallic cover layer contains a ferromagnetic material and that linearly polarised light is used for nanostructuring.

In the nanostructured layer system according to the invention, a surface structure is formed which is formed by substantially anisotropic waves extending along a main direction. Such a structure is often referred to as a “wrinkle” which can be used as a diffraction grating in optical and optoelectronic devices.

As a special feature, the nanostructured layer system according to the invention shows that the orientation of the diffraction grating is dependent on the polarisation direction of the incident light.

In this way a self-organised material is created with the nanostructured layer system, which contains the information about the polarisation plane of the light used for structuring. The nanostructured layer system can thus be used, for example, for information and thus data storage. A readout of the stored information can be read out again via a subsequent diffraction of unpolarised light on the metallic cover layer.

The layer system thus represents an optically controllable material, a so-called “OptiContMat” (optically controlled material). Due to the metallic cover layer, this material has a significantly greater mechanical stability than a material whose structured surface consists of a polymer.

The mechanical stability is dependent on the layer properties and on the individual layer thicknesses. The OptiContMat continues to be distinguished by the optical and ferromagnetic properties in the nano- and microscale range.

An method for producing a nanostructured layer system according to the invention comprises the following steps: A substrate is prepared, and an intermediate layer containing an aromatic azo compound is applied

Subsequently, a metallic cover layer is applied to the intermediate layer and linearly polarised light is irradiated onto the metallic cover layer for light-induced structuring of the intermediate layer and of the metallic cover layer.

By this method, the above-described surface structure is formed, which is characterised by substantially anisotropic waves extending along a main direction where the main direction is substantially perpendicular to the polarisation plane of the incident light.

This results in the advantages described in connection with the nanostructured layer system.

The invention will be explained in more detail by means of embodiments with reference to figures. The figures show:

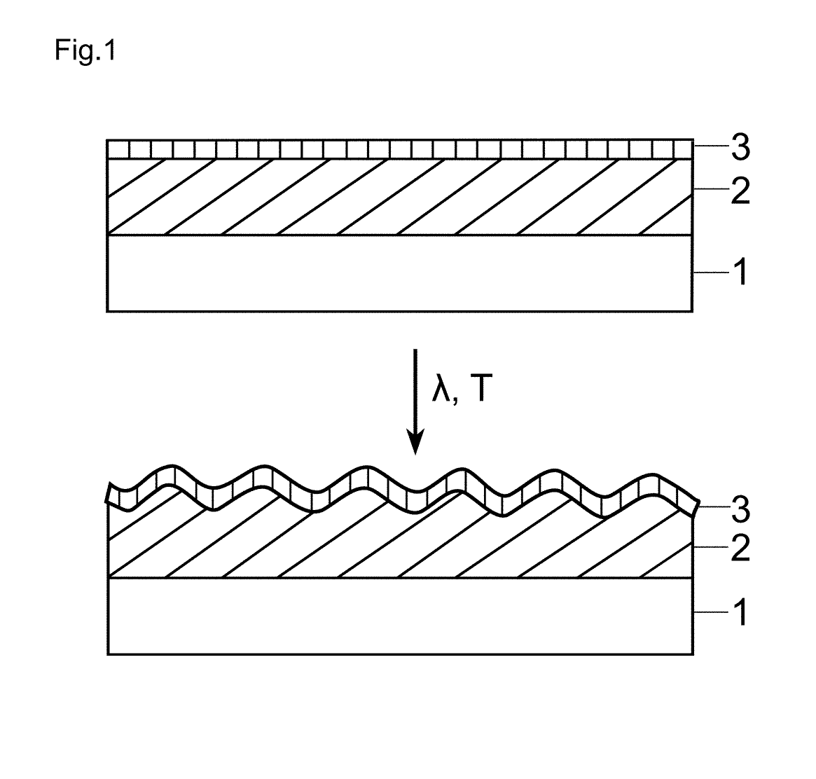

FIG. 1 shows a schematic representation of a method for creating a nanostructured layer system; and

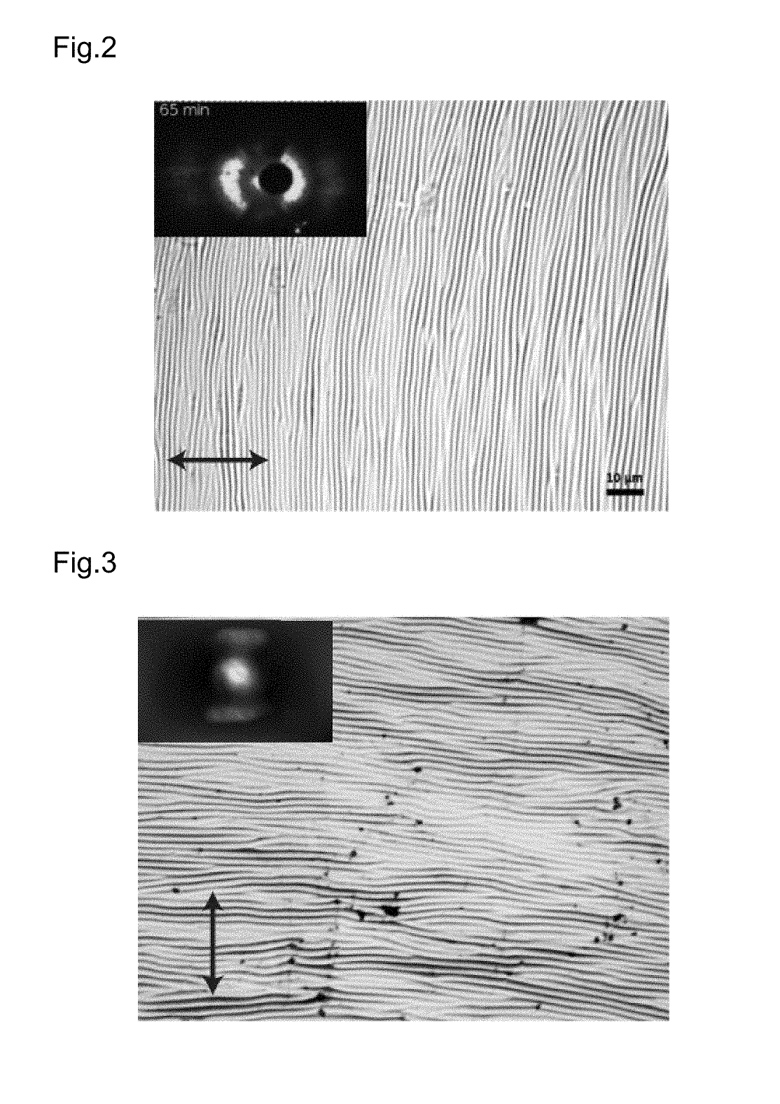

FIG. 2, 3 each show a micrograph of a cover layer of a nanostructured layer system in one exemplary embodiment and a diffraction image produced by this nanostructured layer system with different polarisation directions of the structuring light.

FIG. 1 shows a schematic diagram of a production method for a nanostructured layer system according to the application. In the upper part of the figure, the layer system is shown before structuring.

An intermediate layer 2, which contains an azobenzene-containing low molecular weight glass compound, is first applied to a substrate 1. Such an intermediate layer 2 is also referred to below as azo layer 2. Finally, a metallic cover layer 3 is applied to the azo layer 2, for example through vapour-depositing.

As the substrate 1, a glass substrate or a silicon substrate can be used. The thickness of the substrate 1 is only relevant for the method according to the invention insofar as the substrate 1 should have a sufficient thickness such that a simple production and further processing of the nanostructured layer system is possible. The thickness of the substrate may be, for example, in the range of a few hundred micrometers to the millimetre range. if a silicon substrate is used, it is preferably passivated on its surface by an oxide layer, in particular of silicon dioxide. The substrates are cleaned prior to application of the azo-layer 2, for example with the aid of isopropanol.

As the azo layer 2, In the embodiments described below, a layer of so-called AZOPD (N, N-bis (phenyl)-N, N- to((4-phenylazo) -phenyl) benzidine), a low molecular weight glass, is used. This azo compound has a glass transition temperature of 101° C.

Another characteristic is a strong absorption of ultraviolet and visible radiation, in particular showing a strong absorption line at a wavelength of 439 nm (nanometres). The azo layer 2 is preferably applied to the sample in a spin coating procedure.

For this purpose, the azo compound is dissolved in a solvent, for example chloroform (CH₃Cl) and applied to the substrate 1, which is spinning about 4000 revolutions per minute, as a thin film. The film thickness is 200 nm. The metallic cover layer 3 is preferably applied in a vacuum by a PVD (physical vapour deposition) coating method, for example by heating the metal material in vacuo, evaporating it off and condensing it on the azo layer 2. The layer thickness of the metallic cover layer 3 is in the range of a few nanometres. In the embodiment presented below, nickel was used as the material for the metallic cover layer 3, which was deposited at a thickness of 9 nm at a rate of about 0.002 nm per second and at a pressure of at most 2×10−6 mbar (millibars).

As shown in FIG. 1, after the deposition of the azo layer 2 and the metallic cover layer 3, both the boundary layer between the two layers mentioned and the surface of the metallic cover layer 3 are substantially planar.

To produce the nanostructured layer system, the layer system shown above in FIG. 1 is exposed to light of wavelength λ. In this case, a temperature T is selected, here room temperature, which is significantly below the glass transition temperature of the azo layer 2.

The lower part of FIG. 1 shows the layer system after the light-induced reorientation of the molecules of the azo layer 2 and relaxation of mechanical stresses. Both the boundary layer between the azo layer 2 and the metallic cover layer 3, as well as the surface of the metallic cover layer 3 has a structuring on a microscopic scale.

For structuring, light of wavelength λ of 473 nm is used, i.e. fight in blue colour range. The light may be provided, for example, by a diode-pumped solid state laser (DPSS-diode pumped solid state).

Typical laser energies can be in the range of fifty milliwatts (mW) per square centimetre. Due to the strong dependence of the reorientation phenomena on the absorption wavelength of the azo layer 2 and less on the laser energies, structuring by laser energy below and above 50 mW/cm² is possible.

FIG. 2 shows a microscope image (large image) and a diffraction image (small insert in the upper left in the large image) of an embodiment of a nanostructured layer system.

The layer structure of the layer system corresponds to that shown in FIG. 1, wherein AZOPD was selected as the azo intermediate layer 2 in a thickness of 200 nm and nickel as the metallic cover layer 3 in a thickness of 9 nm. The laser light used for the light-induced structuring is linearly polarised in this example, the polarisation direction being indicated by the double arrow in the lower left image area.

The metallic cover layer 3 is structured in the manner of a surface diffraction grating with the grating lines being at a distance of approximately 2 micrometres (μm). The structuring is homogeneous over the entire depicted section except for a few defects.

The insert in the upper left corner of the image shows a diffraction pattern, which results when light is irradiated or the depicted structure. Even in the diffraction pattern, the anisotropy of the structure is clearly visible. The resulting trenches or peaks of the surface structure run in a main direction, which is substantially perpendicular to the polarisation direction of the laser light used.

The structure is curved slightly arched to the left (based on the representation of FIG. 2).

FIG. 3 again shows, in the same way as FIG. 2, a section of a nano-structured layer structure, the same layer structure being used here as in the example of FIG. 2. The only difference was the direction of the polarised laser light, which in turn is shown on the lower left of the image by the double arrow. Here, too, the main direction in which the wave crests or wave trenches of the layer structure extend is perpendicular to the polarisation direction of the structuring light. Again, a slightly curved course can be seen here.

The microscope and diffraction images of FIGS. 2 and 3 show that the nanostructured layer structure according to the invention, having an AZOPD layer covered by a nickel layer, is structured on its surface along a direction which depends on the polarisation direction of the light used. The information about the polarisation plane of the light is therefore directly reflected in the nanostructure of the nanostructured layer system.

For this reason, the nanostructured layer system described can be used for example for information storage. Further fields of application are nanoelectronics and microelectronics, optics and semiconductors as well as micromechanical production methods, among other things for the medical field.

### REFERENCE NUMBERS

1 Substrate

2 2 Intermediate layer (azo-layer)

3 3 Metallic cover layer

1. Nanostructured layer system, which consists of a combination of materials of an organic layer, in particular azo compound, and metallic cover layer. The invention is now characterized in that the layer system contains an azobenzene-containing molecular glass, in particular azopd, and a cover layer of nickel, this combination of materials being optically directed and controlled by irradiation of linearly polarized light.

2. The nanostructured layer system according to claim 1, wherein the low molecular weight glass layer has a thickness of 200 nm.

3. The nanostructured layer system according to claim 1, wherein the nickel layer has a thickness of 9 nm.

4. Nanostructured layer system according to claim 1, wherein a slightly arcuate surface is formed which has anisotropick waves extending along a main direction, wherein the main direction is perpendicular to a polarisation plane of the incident linear-polarised light.

5. Nanostructured layer system according to claim 1, wherein meaningful layer thickness variation in material combination has an influence on the material properties and the observed optical effects.

6. Nanostructured layer system according to claim 2, wherein a slightly arcuate surface is formed which has anisotropick waves extending along a main direction, wherein the main direction is perpendicular to a polarisation plane of the incident linear-polarised light.

7. Nanostructured layer system according to claim 3, wherein a slightly arcuate surface is formed which has anisotropick waves extending along a main direction, wherein the main direction is perpendicular to a polarisation plane of the incident linear-polarised light.

8. Nanostructured layer system according to claim 2, wherein meaningful layer thickness variation in material combination has an influence on the material properties and the observed optical effects.

9. Nanostructured layer system according to claim 3, wherein meaningful layer thickness variation in material combination has an influence on the material properties and the observed optical effects.

10. Nanostructured layer system according to claim 4, wherein meaningful layer thickness variation in material combination has an influence on the material properties and the observed optical effects.

11. Nanostructured layer system according to claim 6, wherein meaningful layer thickness variation in material combination has an influence on the material properties and the observed optical effects.

12. Nanostructured layer system according to claim 7, wherein meaningful layer thickness variation in material combination has an influence on the material properties and the observed optical effects.
